(19) United States
(12) Patent Application Publication
(10) Pub. No.: US 2007/0162755 A1
(43) Pub. Date: Jul. 12, 2007

(54) Enhancements for discovering device owners in a UPnP searching service

(75) Inventors: Jose Costa-Requena, Helsinki (FI); Seamus Moloney, Riihimaki (FI); Vlad Stirbu, Tampere (FI)

Correspondence Address: FOLEY & LARDNER LLP, P.O. BOX 80278, SAN DIEGO, CA, 92138-0278, US

(73) Assignee: Nokia Corporation

(21) Appl. No.: 11/329,312

(22) Filed: Jan. 9, 2006

(51) Int. Cl. H04L 9/00

(52) U.S. Cl. 713/176

(57) ABSTRACT

A system for selectively granting access rights within a network. When a requesting device learns that a device is a secure device and is owned by a Security Console, the requesting device calls a listowners action to the secure device, which respond by transmitting a public key hash to the requesting device. The requesting device then multicasts a message including the public key hash. Security Consoles receiving the multicast message then determine whether they recognize the public key hash. If a Security Console recognizes the public key hash, then it responds to the multicast message and subsequently provides the requesting device with access rights to the secure device.

### BACKGROUND OF THE INVENTION

The present invention relates generally to Universal Plug and Play (UPnP) devices. More particularly, the present invention relates to the configuration of security settings in UPnP devices.

### BACKGROUND OF THE INVENTION

This section is intended to provide a background or context to the invention that is recited in the claims. The description herein may include concepts that could be pursued, but are not necessarily ones that have been previously conceived or pursued. Therefore, unless otherwise indicated herein, what is described in this section is not prior art to the description and claims in this application and is not admitted to be prior art by inclusion in this section.

Universal Plug and Play (UPnP) technology defines an architecture for pervasive peer-to-peer network connectivity of intelligent appliances, wireless devices, and personal computers of all types. UPnP technology is designed to bring easy-to-use, flexible, standards-based connectivity to ad-hoc or umnanaged networks whether in the home, in a small business, public locations, or systems connected to the Internet. UPnP technology provides a distributed, open networking architecture that leverages TCP/IP and web technologies to enable seamless proximity networking, in addition to providing control and data transfer among networked devices.

The UPnP security framework defines the mechanism that allows a user to set up security in a devices using what is commonly referred to as a Security Console. The Security Console allows the user to take ownership of the UPnP devices, activate control access lists, etc. The Security Console is the only component that has administrator rights over the device and is able to change the access control. UPnP allows any device to become a Security Console and take ownership of other UPnP devices. Therefore, in a normal UPnP network, several Security Consoles will own different devices.

If a new user that enters a network wants to use one of the devices (e.g., a media server), the new user must first obtain the rights from the Security Console that owns the device. Currently, the UPnP security parameters do not define how the new control point can discover the Security Console that owns the device. According to the UPnP specifications, a new user would have to query every Security Console in the network and then register with each Security Console in order to determine which one is the owner. In UPnP terms, the new user (i.e., the control point) has to call presentkeys (i.e., UPnP action) on each Security Console before trying again to access the secure device. This is quite inefficient, as it requires that the control point receive a relatively large amount of information that it does not otherwise require or desire.

### SUMMARY OF THE INVENTION

The present invention involves the addition of a number of extensions into the UPnP searching service in order to discover the owner of a device. The secure device, such as a media server, includes a device description which indicates that it is a secure device. In various embodiments of the invention, when the new user (i.e., the control point) observes that the device is “Security Aware,” it calls a “listowners” UPnP action to that device in order to obtain the public key hashes of the respective owner device or devices. The control point then adds the public key hashes of the owner device or devices (or a suitable header) to the simple service discover protocol (SSDP) discover message that it will send. The Security Consoles available in the network will receive the multicast search message, and they will interpret the search target information in the message (i.e., in ST header or in a new SSDP header) that includes the hash of the public key of the Security Console owning the device. By using this mechanism, only Security Consoles which recognizes the public key will respond.

In an additional embodiment of the invention, the secure device transmits the public key hashes of the owner device or devices, as well as the universally unique identifier (UUID) of the owner device or devices, to the control point. The control point then performs a standard search query using the universally unique identifier in order to communicate with the respective Security Console owner device or devices. The Security Consoles available in the network will receive the multicast search message including the UUID in the search target information (i.e. the ST header). Only the Security Console with the UUID included in the multicast message will respond to the Control Point as the owner of the device.

The present invention comprises a method, computer program product and device for obtaining access rights to a device from a Security Console. Upon learning that the device is a secure device, a listowners action is called to the secure device. A public key hash is received from the secure device in response to the listowners action. A message is then multicast, including the public key hash, in the search target information (i.e., in the ST header or new SSDP header) within the multicast search message. The Security Console will receive the multicast message and will interpret the search target information in the message (i.e. in the ST header or new SSDP header). The multicast message is received by all of the Security Consoles in the network, and all of the Security Consoles will interpret the search target information that includes the public key hash of the Security Console owner of the device. A response message will then be received from only a Security Console that recognizes the multicast public key hash.

The present invention also comprises a method, computer program product and device for using a Security Console to provide access rights for a secure device to a requesting device (i.e., a control point). A multicast message is received from the requesting device. The multicast message includes a public key hash having been obtained from the secure device in response to a listowners message. It is then determined if the public key hash is recognized by the Security Console and, if so, a response message is transmitted to the requesting device acknowledging that the public key hash is recognized by the Security Console. The Security Console may then later provide certain access rights to the requesting device.

The present invention further comprises a system for selectively granting access rights within a network. A requesting device is configured to transmit a listowners action to a secure device. The secure device is configured to receive the listowners action from the requesting device and to respond by transmitting a public key hash of the Security Console registered as owner of the device (and/or the UUID of the Security Console owner of the device) to the requesting device. A Security Console is registered as the owner of the secure device and is configured to receive a multicast message including the public key hash from the requesting device; determine if the public key hash (or Security Console UUID) is recognized by the Security Console; and, if the public key hash (or Security Console UUID) is recognized by the Security Console, subsequently grant certain access rights for the secure device to the requesting device.

With the present invention, a user is able to easily obtain information about the owner of a secure device so that the user can directly contact the owner in order to request access rights to the secure device. Additionally, by not having to receive and process information for every Security Console located within the network, the present invention leads to a more efficient information-gathering process than has been previously possible.

These and other advantages and features of the invention, together with the organization and manner of operation thereof, will become apparent from the following detailed description when taken in conjunction with the accompanying drawings, wherein like elements have like numerals throughout the several drawings described below.

### BRIEF DESCRIPTION OF THE DRAWINGS

FIG. 1 is a perspective view of an electronic device that can be used in the implementation of the present invention;

FIG. 2 is a schematic representation of the telephone circuitry of the electronic device of FIG. 1;

FIG. 3 is a diagram of a network including a plurality of secure devices, a plurality of Security Consoles, and a requesting device according to the principles of the present invention;

FIG. 4 is a flow chart showing the process for implementing various embodiments of the present invention; and

FIG. 5 is a flow chart showing the process for implementing an additional embodiment of the present invention.

### DETAILED DESCRIPTION OF THE PREFERRED EMBODIMENTS

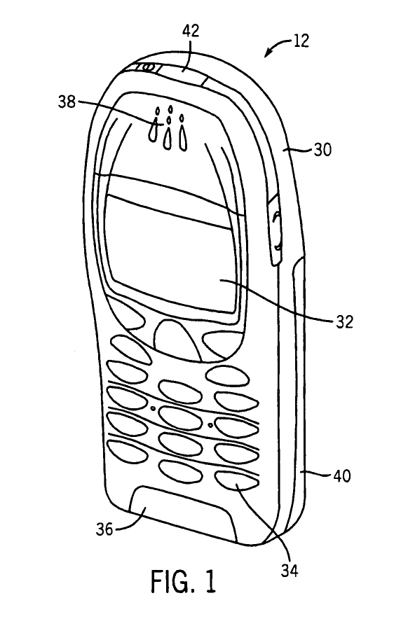

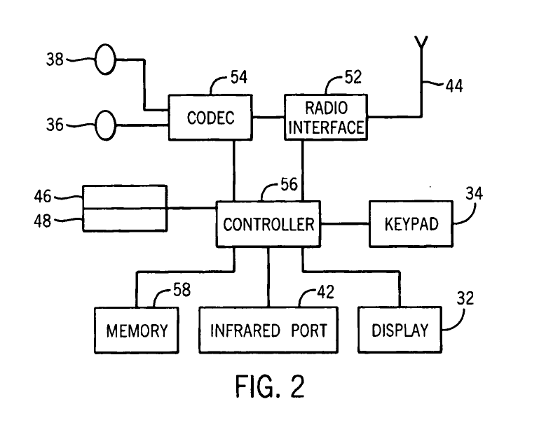

FIGS. 1 and 2 show one representative electronic device 12 within which the present invention may be implemented. It should be understood, however, that the present invention is not intended to be limited to one particular type of electronic device. For example, the present invention can be incorporated into a combination personal digital assistant (PDA) and mobile telephone, a PDA, a mobile telephone, an integrated messaging device (IMD), a desktop computer, and a notebook computer. The electronic device 12 of FIGS. 1 and 2 includes a housing 30, a display 32 in the form of a liquid crystal display, a keypad 34, a microphone 36, an ear-piece 38, a battery 40, an infrared port 42, an antenna 44, a smart card 46 in the form of a universal integrated circuit card (UICC) according to one embodiment of the invention, a system clock 43, a card reader 48, radio interface circuitry 52, codec circuitry 54, a controller 56 and a memory 58. Individual circuits and elements are all of a type well known in the art, for example in the Nokia range of mobile telephones.

The communication devices implementing the present invention may communicate using various transmission technologies including, but not limited to, Code Division Multiple Access (CDMA), Global System for Mobile Communications (GSM), Universal Mobile Telecommunications System (UMTS), Time Division Multiple Access (TDMA), Frequency Division Multiple Access (FDMA), Transmission Control Protocol/Internet Protocol (TCP/IP), Short Messaging Service (SMS), Multimedia Messaging Service (MMS), e-mail, Instant Messaging Service (IMS), Bluetooth, IEEE 802.11, etc.

The present invention involves the additions of extensions into the UPnP searching service in order to discover the owner of a device. The secure device, such as a media server, includes a device description which indicates that it is a secure device. When the new user (i.e., a new control point) observes that the device is Security Aware, it calls a “listowners” action to that device in order to obtain the public key hashes (and/or UUID) of the respective owner devices. The control point then adds the public key hashes (or UUID) of the owner devices (or a suitable header) to the SSDP discover message that it will send. By using this mechanism, only the Security Console or Consoles which recognize the public key will respond to the SSDP discover message.

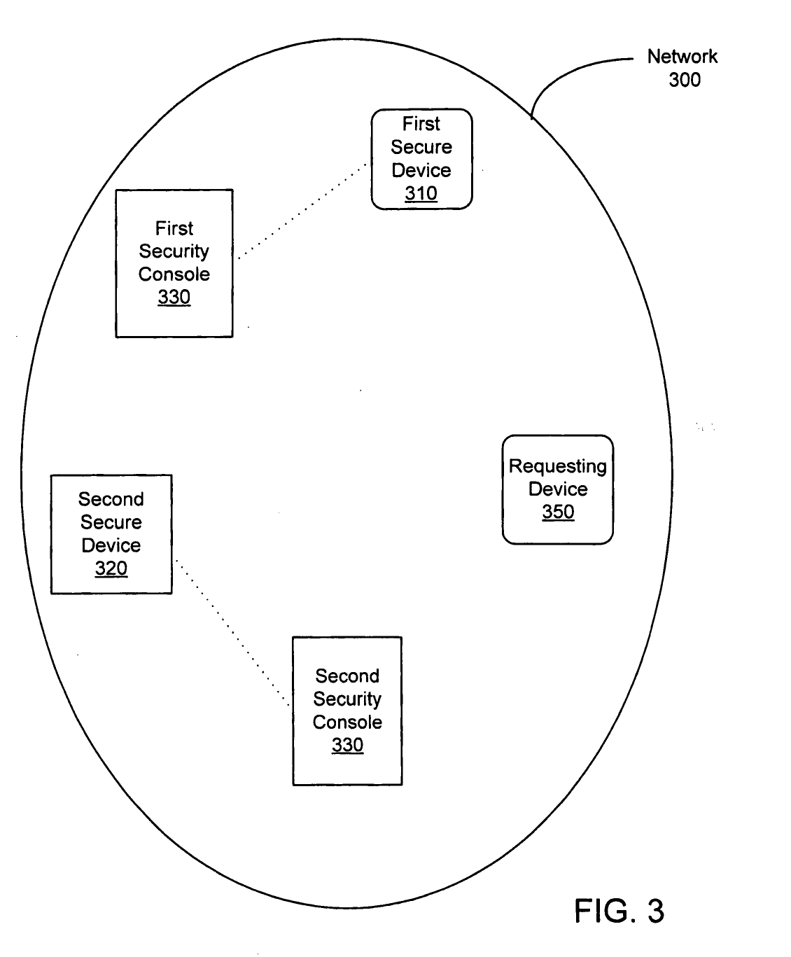

FIG. 3 shows a sample network 300 including a first secure device 310, a second secure device 320, a first Security Console 330 and a second security Console 340. In this instance, the first Security Console 330 is the owner of the first secure device 310, while the second Security Console 340 is the owner of the second secure device 320. The first and second secure devices 310 and 320 can comprise, for example, media servers. The network 300 further includes a requesting device 350 which desires to access the first secure device 310.

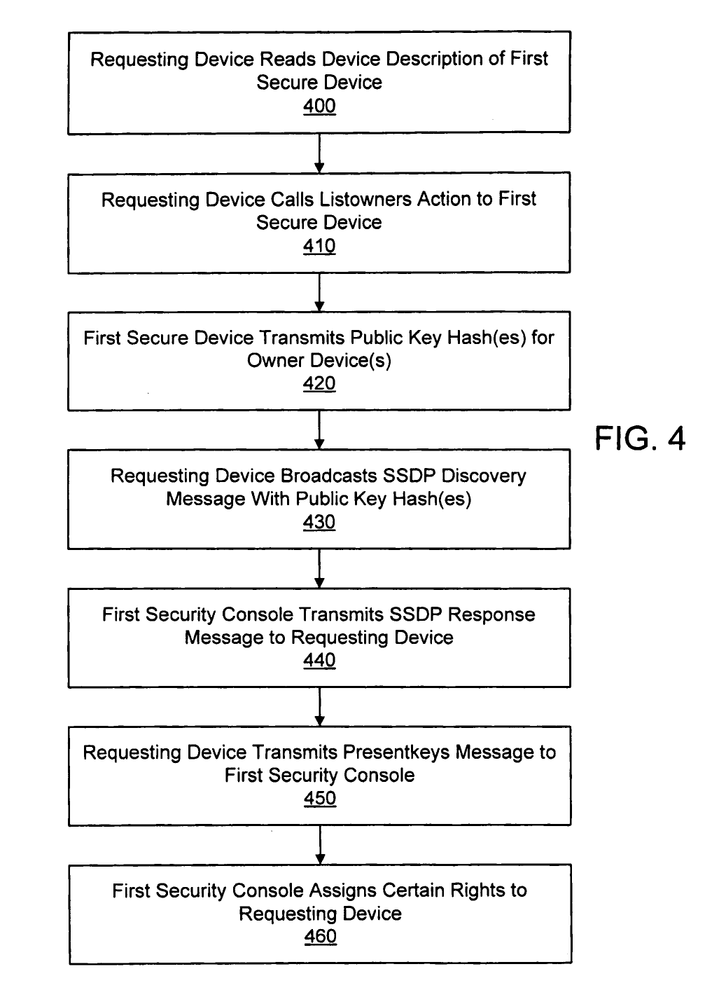

FIG. 4 shows a process for implementing various embodiments of the present invention. At step 400 in FIG. 4, the requesting device 350 desires to access the first secure device 310. At this point, the requesting device 350 reads a device description for the first secure device 310, which indicates that the first secure device 310 is security aware. In response to learning this information, at step 410 the requesting device 350 calls a “listowners” action to the first secure device 310. With this action, the requesting device 350 obtains the public key hash for the owner device of the first secure device 310. At step 420, the first secure device 310 transmits the public key hash for the owner device to the requesting device 350.

At step 430, the requesting device 350 multicasts a SSDP discovery message. This discovery message includes information that operates to inform the requesting device 350 of the identity of the Security Console that is the owner of the first secure device 310. In a first embodiment of the present invention, the SSDP discovery message includes “service type=Security Console” in the search target header, as well as an additional parameter that includes the public key hash of the specific Security Console which is being searched for (e.g., “service type=Security Console; key=#$$52#”). The public key hash was obtained from the first secure device 310 at step 420. In another embodiment of the invention, in addition to the “service type=Security Console” message, a new SSDP header is included in the SSDP discovery message. This new header includes the hash of the public key for the owner device or devices. In either of these embodiments, the identified public key hash will be the hash for the first Security Console 330.

At step 440, instead of both the first and second Security Consoles 330 and 340 responding to the requesting device's SSDP discovery message, only the Security Console which recognize the identified public key hash respond to the SSDP discovery message. In this instance, only the first Security Console 330 transmits a SSDP response to the requesting device 350. Once the requesting device 350 has received this information, the requesting device 350 can transmit a presentkeys message to the first Security Console 330 at step 450. At step 460 and based upon the presented keys, the first Security Console 330 will assign certain rights to the requesting device 350, permitting the requesting device 350 to access the first secure device 310.

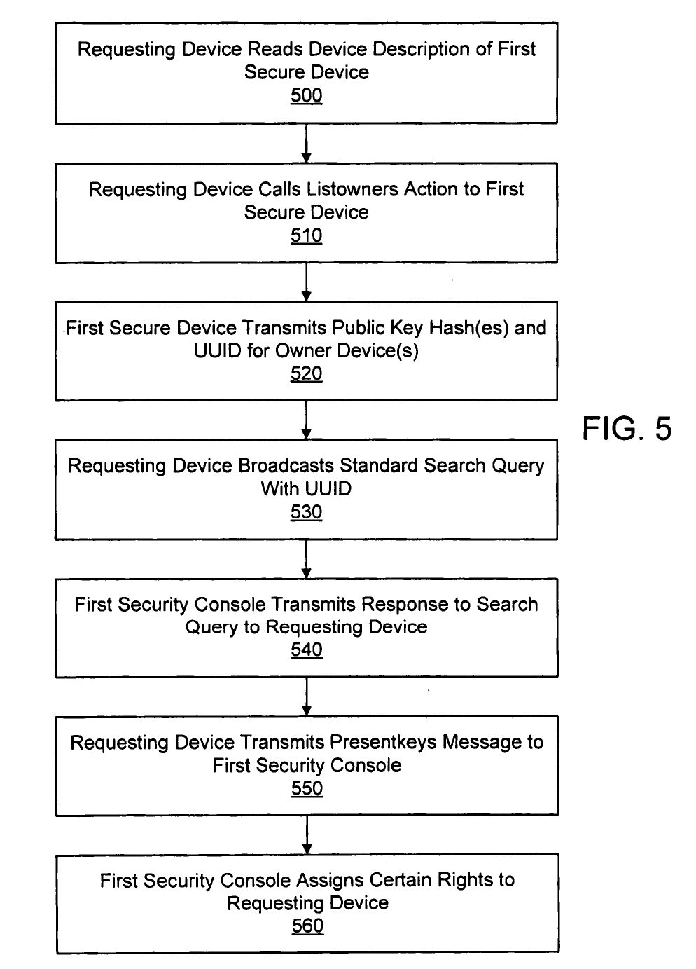

Another embodiment of the present invention is depicted in FIG. 5. In this embodiment, at step 400, the requesting device 350 desires to access the first secure device 310. As in the embodiments discussed in FIG. 4, the requesting device 350 reads a device description for the first secure device 310, which indicates that the first secure device 310 is security aware. In response to learning this information, at step 510 the requesting device calls a “listowners” action to the first secure device 310. At step 420, the first secure device 310 responds by transmitting the public key hash for the owner device (the public ID) to the requesting device 350, as well as a new parameter that includes the universally unique identifier (UUID) of the first secure device's owner (the first Security Console 310 in the situation depicted in FIG. 3). At step 530 and upon receiving this information from the first secure device 310, the requesting device 350 multicasts a standard search query using the UUID instead of the search target header discussed in FIG. 4. The first Security Console 330 responds to this search query at step 540, after which the requesting device 350 transmits a presentkeys message to the first Security Console 330 at step 550. At step 560 and based upon the presented keys, the first Security Console 330 assigns certain rights to the requesting device 350, permitting the requesting device to access the first secure device 310.

The present invention is described in the general context of method steps, which may be implemented in one embodiment by a program product including computer-executable instructions, such as program code, executed by computers in networked environments. Generally, program modules include routines, programs, objects, components, data structures, etc. that perform particular tasks or implement particular abstract data types. Computer-executable instructions, associated data structures, and program modules represent examples of program code for executing steps of the methods disclosed herein. The particular sequence of such executable instructions or associated data structures represents examples of corresponding acts for implementing the functions described in such steps. A computer program product including code to implement steps and process of the present invention can be embedded in a wide variety of computer-readable media, including but not limited to hard drives, compact disks, floppy disks, carrier waves, and other media.

Software and web implementations of the present invention could be accomplished with standard programming techniques with rule based logic and other logic to accomplish the various database searching steps, correlation steps, comparison steps and decision steps. It should also be noted that the words “component” and “module,” as used herein and in the claims, is intended to encompass implementations using one or more lines of software code, and/or hardware implementations, and/or equipment for receiving manual inputs.

The foregoing description of embodiments of the present invention have been presented for purposes of illustration and description. It is not intended to be exhaustive or to limit the present invention to the precise form disclosed, and modifications and variations are possible in light of the above teachings or may be acquired from practice of the present invention. The embodiments were chosen and described in order to explain the principles of the present invention and its practical application to enable one skilled in the art to utilize the present invention in various embodiments and with various modifications as are suited to the particular use contemplated.

What is claimed is:

1. A method of obtaining access rights to a device from a Security Console, comprising:
after learning that the device is a secure device, calling a listowners action to the secure device;
receiving a public key hash from the secure device in response to the listowners action;
multicasting a message including the public key hash in response to receipt of the public key hash; and
receiving a response message from only a Security Console that recognizes the multicast public key hash.

2. The method of claim 1, wherein the multicast message comprises an SSDP discovery message.

3. The method of claim 2, wherein the SSDP discovery message includes a search target header comprising the public key hash and a “service type=Security Console” message.

4. The method of claim 2, wherein the SSDP discovery message includes:
a search target header including a “service type=Security Console” message; and
an additional SSDP header including the public key hash.

5. The method of claim 1, wherein the multicast message comprises a standard search query.

6. The method of claim 5, wherein, in response to the listowners action, a universally unique identifier for the Security Console is received with the public key hash, and wherein the universally unique identifier is included in the standard search query.

7. The method of claim 1 further comprising:
after receiving the response message, transmitting a presentkeys message to the Security Console; and
in response to the presentkeys message, receiving from the Security Console certain rights to access the secure device.

8. A computer program product embedded in a computer-readable medium for obtaining access rights to a device from a Security Console, comprising:
computer code for, after learning that the device is a secure device, calling a listowners action to the secure device;
computer code for receiving a public key hash from the secure device in response to the listowners action;
computer code for multicasting a message including the public key hash in response to receipt of the public key hash; and
computer code for receiving a response message from only a Security Console that recognizes the multicast public key hash.

9. The computer program product of claim 8, wherein the multicast message comprises an SSDP discovery message.

10. The computer program product of claim 9, wherein the SSDP discovery message includes a search target header comprising the public key hash and a “service type=Security Console” message.

11. The computer program product of claim 9, wherein the SSDP discovery message includes:
a search target header including a “service type=Security Console” message; and
an additional SSDP header including the public key hash.

12. The computer program product of claim 8, wherein the multicast message comprises a standard search query and wherein, in response to the listowners action, a universally unique identifier for the Security Console is received with the public key hash, the universally unique identifier being included in the standard search query.

13. The computer program product of claim 8, further comprising:
computer code for, after receiving the response message, transmitting a presentkeys message to the Security Console; and
computer code for, in response to the presentkeys message, receiving from the Security Console certain rights to access the secure device.

14. An electronic device, comprising:
a processor; and
a memory unit communicatively connected to the processor and including a computer program product for obtaining access rights to a device from a Security Console, comprising:
computer code for, after learning that the device is a secure device, calling a listowners action to the secure device;
computer code for receiving a public key hash from the secure device in response to the listowners action;
computer code for multicasting a message including the public key hash in response to receipt of the public key hash; and
computer code for receiving a response message from only a Security Console that recognizes the multicast public key hash.

15. The electronic device of claim 14, wherein the multicast message comprises an SSDP discovery message.

16. The electronic device of claim 15, wherein the SSDP discovery message includes a search target header comprising the public key hash and a “service type=Security Console” message.

17. The electronic device of claim 15, wherein the SSDP discovery message includes:
a search target header including a “service type=Security Console” message; and
an additional SSDP header including the public key hash.

18. The electronic device of claim 14, wherein the multicast message comprises a standard search query and wherein, in response to the listowners action, a universally unique identifier for the Security Console is received with the public key hash, the universally unique identifier being included in the standard search query.

19. The electronic device of claim 14, wherein the memory unit further comprises:
computer code for transmitting a presentkeys message to the Security Console; and
computer code for, in response to the presentkeys message, receiving from the Security Console certain rights to access the secure device.

20. A method of using a Security Console to provide access rights for a secure device to a requesting device, comprising:
receiving from the requesting device a multicast message including a public key hash, the public key hash having been obtained from the secure device in response to a listowners message;
determining if the public key hash is recognized by the Security Console; and
if the public key hash is recognized by the Security Console, transmitting a response message to the requesting device, the response message acknowledging that the public key hash is recognized by the Security Console.

21. The method of claim 20, wherein the multicast message comprises an SSDP discovery message.

22. The method of claim 21, wherein the SSDP discovery message includes a search target header comprising the public key hash and a “service type=Security Console” message.

23. The method of claim 21, wherein the SSDP discovery message includes:
a search target header including a “service type=Security Console” message; and
an additional SSDP header including the public key hash.

24. The method of claim 20, wherein the multicast message comprises a standard search query.

25. The method of claim 24, wherein a universally unique identifier obtained by the requesting device from the secure device is included in the standard search query, and wherein a response message is transmitted to the requesting device only if the universally unique identifier transmitted by the requesting device is the universally unique identifier for the Security Console.

26. The method of claim 20, further comprising:
receiving a presentkeys message from the requesting device; and
in response to the presentkeys message, transmitting certain access rights for the secure device to the requesting device.

27. A computer program product embedded in a computer-readable medium for using a Security Console to provide access rights for a secure device to a requesting device, comprising:
computer code for receiving from the requesting device a multicast message including a public key hash, the public key hash having been obtained from the secure device in response to a listowners message;
computer code for determining if the public key hash is recognized by the Security Console; and
computer code for, if the public key hash is recognized by the Security Console, transmitting a response message to the requesting device, the response message acknowledging that the public key hash is recognized by the Security Console.

28. The computer program product of claim 27, wherein the multicast message comprises an SSDP discovery message.

29. The computer program product of claim 28, wherein the SSDP discovery message includes a search target header comprising the public key hash and a “service type=Security Console” message.

30. The computer program product of claim 28, wherein the SSDP discovery message includes:
a search target header including a “service type=Security Console” message; and
an additional SSDP header including the public key hash.

31. The computer program product of claim 27, wherein the multicast message comprises a standard search query, wherein a universally unique identifier obtained by the requesting device from the secure device is included in the standard search query, and wherein the response message is transmitted to the requesting device only if the universally unique identifier transmitted by the requesting device is the universally unique identifier for the Security Console.

32. A Security Console configured to selectively provide access rights for a secure device to a requesting device, comprising:
a processor; and
a memory unit operatively connected to the processor and including:
computer code for receiving from the requesting device a multicast message including a public key hash, the public key hash having been obtained from the secure device in response to a listowners message;
computer code for determining if the public key hash is recognized by the Security Console; and
computer code for, if the public key hash is recognized by the Security Console, transmitting a response message to the requesting device, the response message acknowledging that the public key hash is recognized by the Security Console.

33. The electronic device of claim 32, wherein the memory unit further comprises:
computer code for, after transmitting the response message, receiving a presentkeys message from the requesting device; and
computer code for, in response to the presentkeys message, transmitting certain access rights for the secure device to the requesting device.

34. A system for selectively granting access rights within a network, comprising:
a requesting device;
a secure device configured to receive a listowners action from the requesting device and respond by transmitting a public key hash to the requesting device; and
a Security Console registered as the owner of the secure device; the Security Console configured to:
receive a multicast message including the public key hash from the requesting device;
determine if the public key hash is recognized by the Security Console; and
if the public key hash is recognized by the Security Console, grant certain access rights for the secure device to the requesting device.
